(19) United States
(12) Patent Application Publication
(10) Pub. No.: US 2025/0223839 A1
(43) Pub. Date: Jul. 10, 2025

(54) ELECTRIFIED LATCH ASSEMBLY

(71) Applicant: Schlage Lock Company LLC, Carmel, IN (US)

(72) Inventors: Ramakrishna Moorthy Andamuthu, Pollachi (IN); Ashwin Bajikar, Belagavi (IN); Hariom Choudhary, Samastipur (IN); Rohith Badhya, Bangalore (IN)

(21) Appl. No.: 18/407,000

(22) Filed: Jan. 8, 2024

(51) Int. Cl. E05B 47/00; E05B 55/00

(52) U.S. Cl. CPC E05B 47/0012; E05B 55/00; E05B 2047/0017; E05B 2047/002; E05B 2047/0024; E05B 2047/0036; E05B 2047/0054

(57) ABSTRACT

An exemplary latch assembly generally includes a tubular housing, a latchbolt, a slide member, a rotary member, and a motor. The latchbolt is mounted for sliding movement in the tubular housing between an extended position and a retracted position, and the latchbolt is biased toward the extended position. The slide member is slidably mounted within the tubular housing and engaged with the latchbolt such that the slide member is operable to retract the latchbolt. The rotary member is rotatably mounted in the tubular housing and engaged with the slide member. The motor is operable to rotate the rotary member in a first rotational direction, and rotation of the rotary member in the first rotational direction drives the slide member in a first linear direction to thereby retract the latchbolt. Further embodiments, forms, features, and aspects of the present application shall become apparent from the description and figures provided herewith.

### TECHNICAL FIELD

The present disclosure generally relates to electrified latch assemblies, and more particularly but not exclusively relates to electrified tubular latch assemblies.

### BACKGROUND

Many currently-available electronic locksets include an electric clutch mechanism by which the locked/unlocked state of the lockset can be adjusted electronically. These locksets typically include a handle that must be rotated while the lockset is unlocked in order to retract the latch. While some existing access control devices provide for electronic latch retraction, these devices typically require a solenoid or a bulky motor that cannot fit in existing standard installation envelopes. For these reasons among others, there remains a need for further improvements in this technological field.

### SUMMARY

An exemplary latch assembly generally includes a tubular housing, a latchbolt, a slide member, a rotary member, and a motor. The latchbolt is mounted for sliding movement in the tubular housing between an extended position and a retracted position, and the latchbolt is biased toward the extended position. The slide member is slidably mounted within the tubular housing and engaged with the latchbolt such that the slide member is operable to retract the latchbolt. The rotary member is rotatably mounted in the tubular housing and engaged with the slide member. The motor is operable to rotate the rotary member in a first rotational direction, and rotation of the rotary member in the first rotational direction drives the slide member in a first linear direction to thereby retract the latchbolt. Further embodiments, forms, features, and aspects of the present application shall become apparent from the description and figures provided herewith.

### BRIEF DESCRIPTION OF THE FIGURES

FIG. 1 is an exploded assembly view of a lockset according to certain embodiments installed to a door.

FIG. 2 is a schematic block diagram of the lockset.

FIG. 3 is an exploded assembly view of a latch assembly according to certain embodiments.

FIG. 4 is an exploded assembly view of a drive assembly according to certain embodiments.

FIG. 5 illustrates the latch assembly in a home state.

FIG. 6 illustrates the latch assembly in an electronically actuated state.

FIG. 7 illustrates the latch assembly in a home state.

FIG. 8 illustrates the latch assembly in a mechanically actuated state.

FIG. 9 is a schematic block diagram of a computing device that may be utilized in connection with certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

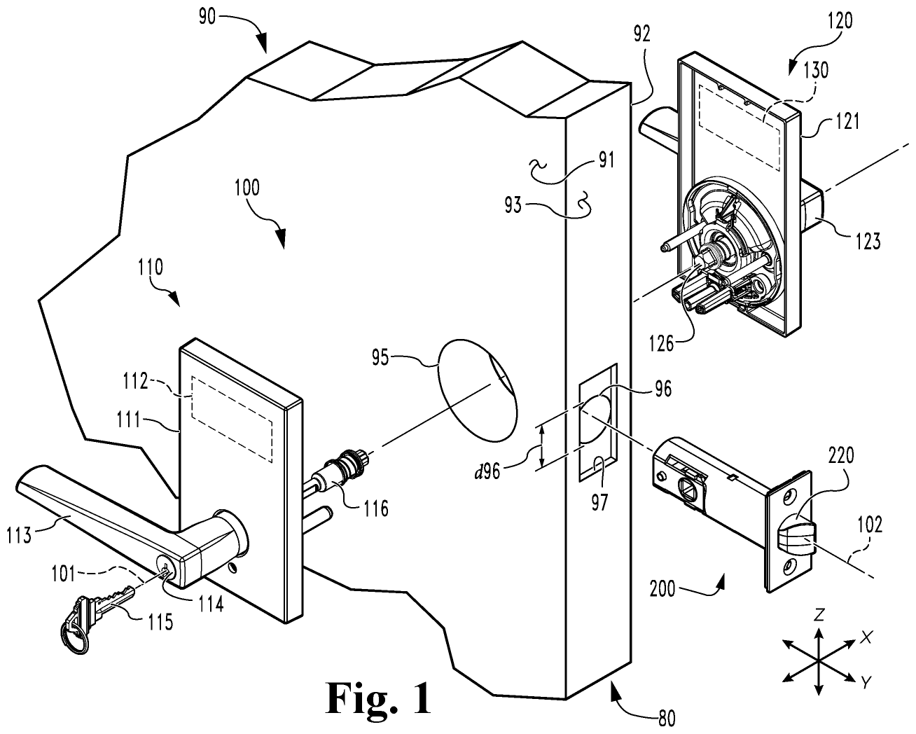

As used herein, the terms “longitudinal,” “lateral,” and “transverse” may be used to denote motion or spacing along three mutually perpendicular axes, wherein each of the axes defines two opposite directions. In the coordinate system illustrated in FIG. 1, the X-axis defines first and second longitudinal directions, the Y-axis defines first and second lateral directions, and the Z-axis defines first and second transverse directions. These terms are used for ease and convenience of description, and are without regard to the orientation of the system with respect to the environment. For example, descriptions that reference a longitudinal direction may be equally applicable to a vertical direction, a horizontal direction, or an off-axis orientation with respect to the environment.

Furthermore, motion or spacing along a direction defined by one of the axes need not preclude motion or spacing along a direction defined by another of the axes. For example, elements that are described as being “laterally offset” from one another may also be offset in the longitudinal and/or transverse directions, or may be aligned in the longitudinal and/or transverse directions. Moreover, the term “transverse” may also be used to describe motion or spacing that is non-parallel to a particular axis or direction. For example, an element that is described as being “movable in a direction transverse to the longitudinal axis” may move in a direction that is perpendicular to the longitudinal axis and/or in a direction oblique to the longitudinal axis. The terms are therefore not to be construed as limiting the scope of the subject matter described herein to any particular arrangement unless specified to the contrary.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

With reference to FIG. 1, illustrated therein is a closure assembly 80 including a door 90 and a lockset 100 according to certain embodiments. The lockset 100 is configured for installation to the door 90, and generally includes an outside assembly 110, an inside assembly 120, and a latch assembly 200 according to certain embodiments. As described herein, in the illustrated embodiment, the latch assembly 200 is connected with the outside assembly 110 and the inside assembly 120 such that the lockset 100 is operable to be actuated from each side of the door 90. It is also contemplated that the latch assembly 200 may be operable to be actuated from only one side of the door 90.

The door 90 has an exterior or non-egress side 91, an interior or egress side 92 opposite the non-egress side 91, a latch edge 93 connecting the non-egress side 91 and the egress side 92, and a door preparation 94 that facilitates the mounting and installation of the lockset 100. The door preparation 94 includes a cross-bore 95 that extends through the width of the door 90 between the non-egress side 91 and the egress side 92, a latch bore 96 that extends into the door 90 from the latch edge 93 and intersects the cross-bore 95, and may further include a recessed area 97 that is recessed into the latch edge 93. While other forms are contemplated, in the illustrated embodiment, the door preparation 94 is a standard commercial door preparation in which the cross-bore 95 has a diameter of 2⅛ inches, the latch bore 96 has a diameter d96 of one inch, and the recessed area 97 has a depth of ⅛ inch.

The lockset 100 has a longitudinal axis 101 and a lateral axis 102. The longitudinal axis 101 extends through the thickness of the door 90 in the direction defined by the central axis of the cross-bore 95. As described herein, the longitudinal axis 101 may define a rotational axis for one or more components of the lockset 100, such as an outside spindle 116 and/or an inside spindle 126. The lateral axis 102 is transverse to the longitudinal axis 101, and extends in the direction defined by the central axis of the latch bore 96. As described herein, a latchbolt 220 of the latch assembly 200 is mounted for movement along the lateral axis 102 between an extended position and a retracted position.

The exterior assembly 110 is mounted to the non-egress side 91 of the door 90, and in the illustrated form generally includes an outside escutcheon 111, a credential reader 112 mounted to the escutcheon 111, an outside handle 113, a lock cylinder 114 mounted in the handle 113, and an outside spindle 116 mounted for rotation relative to the escutcheon 111 and engaged with the latch assembly 200. As described herein, the outside spindle 116 may be configured to rotate in response to actuation of the handle 113 and/or the lock cylinder 114, and may be configured to actuate the latch assembly 200 when rotated.

The credential reader 112 is configured to read a credential, and to transmit to a controller (e.g., a controller 132 of the interior assembly 120) information related to the credential. The credential reader 112 may, for example, include one or more of the following: a biometric credential reader operable to read a biometric credential (e.g., a fingerprint, retinal pattern, iris pattern, etc.); a card reader operable to read a card-based credential (e.g., a proximity card, an RFID tag); a mobile device reader operable to read a digital credential stored on the mobile device; and/or a keypad operable to read a code-based credential (e.g., a PIN code, password). While the illustrated credential reader 112 is mounted to the outside escutcheon 111, it should appreciated that the credential reader 112 may be mounted elsewhere, such as on the door 90 or the wall or door frame adjacent the door 90.

The handle 113 is mounted to the escutcheon 111, and in the illustrated form is provided in the form of a lever. It is also contemplated that the handle 113 may be provided in another form, such as that of a knob. In certain embodiments, the handle 113 may be rotatably mounted to the escutcheon 111. In other forms, the handle 113 may be a dummy handle that has a fixed orientation relative to the escutcheon 111 regardless of the locked/unlocked state of the lockset 100. The illustrated lock cylinder 114 is mounted in the handle 113, and is operable to be actuated by an appropriate key 115. In the illustrated form, the lock cylinder 114 is connected with the outside spindle 116 such that the outside spindle 116 rotates in response to actuation of the lock cylinder 114 by the key 115.

The interior assembly 120 is mounted to the egress side 92 of the door 90, and in the illustrated form generally includes an inside escutcheon 121, an inside handle 123 mounted to the escutcheon 121, and an inside spindle 126 mounted for rotation relative to the escutcheon 121 and engaged with the latch assembly 200. While other forms are contemplated, in the illustrated embodiment, the inside handle 123 is at all times capable of rotating the inside spindle 126 for actuation of the latch assembly 200 to thereby provide for unrestricted free egress.

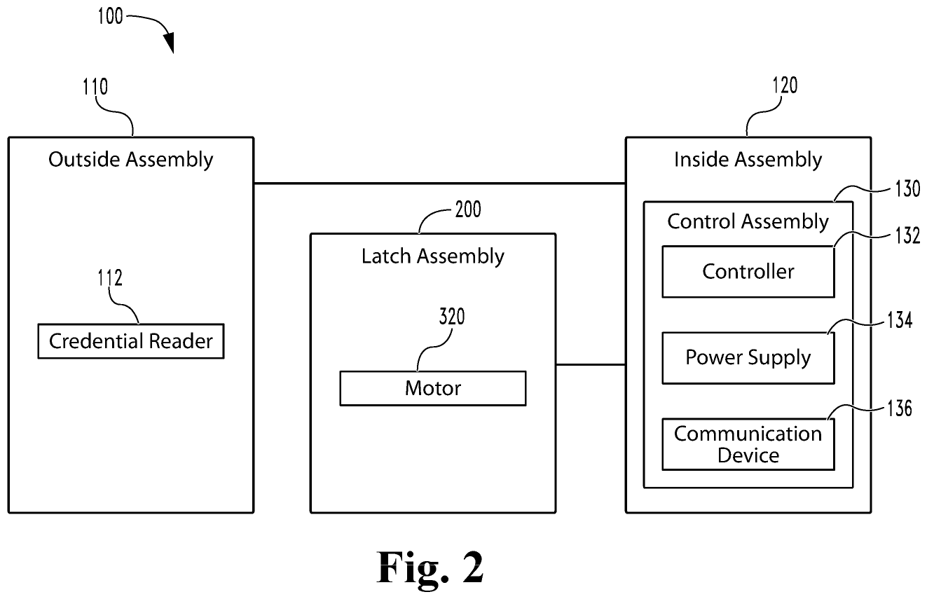

With additional reference to FIG. 2, the lockset 100 further includes a control assembly 130, which in the illustrated form is provided in the inside assembly 110. The control assembly 130 is in communication with a motor 320 of the latch assembly 200, and is configured to actuate the latch assembly 200 electronically. For example, the control assembly 130 may cause the latch assembly 200 to retract the latchbolt 220 in response to a first criterion, and may cause the latch assembly 200 to extend the latchbolt 220 in response to a second criterion.

In the illustrated form, the control assembly 130 is in communication with the credential reader 112, and the first criterion relates to credential information received from the credential reader 112. For example, the control assembly 130 may transmit a retract signal operative to cause the motor 320 to retract the latchbolt 220 in response to determining that the credential information received from the credential reader 112 corresponds to an authorized credential. The control assembly 130 may additionally be configured to transmit a return signal that causes the latch assembly 200 to return the latchbolt 220 to its extended position. The control assembly 130 may transmit the return signal in response to a second criterion, such as expiration of a relock timer that may, for example, be initiated upon transmission of the retract signal.

The illustrated control assembly 130 generally includes a controller 132, and in certain forms may further include a power supply 134 and/or a communication device 136. For example, the power supply 134 may take the form of an onboard power supply, such as a battery or super capacitor. It is also contemplated that the lockset 100 may not necessarily have an onboard power supply, such as in embodiments in which the lockset 100 is configured for connection to line power. The communication device 136 may facilitate communication between the control assembly 130 and an external device, such as a mobile device, a gateway, a router, a smart home system, or an access control system. The communication device 136 may include a wireless communication device and/or a wired communication device.

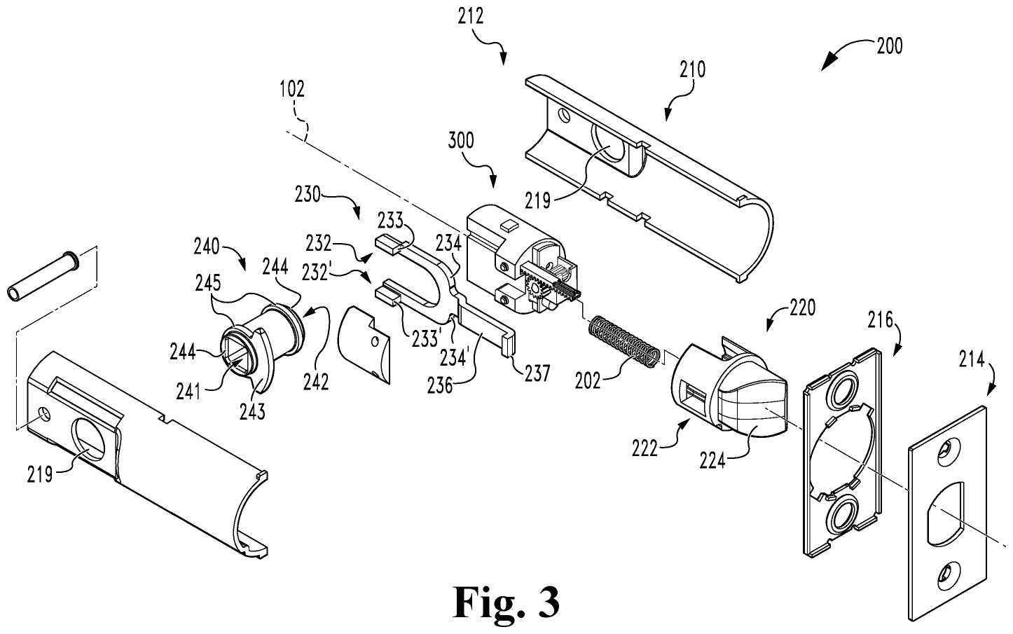

With additional reference to FIG. 3, the latch assembly 200 generally includes a housing assembly 210, a latchbolt 220 mounted in the housing assembly 210 for movement along the lateral axis 102 between an extended position and a retracted position, a bolt bar 230 operable to retract the latchbolt 220, a drive cam 240 operable to mechanically retract the bolt bar 230 for mechanical actuation of the latch assembly 200, and a drive assembly 300 operable to electronically retract the bolt bar 230 for electronic actuation of the latch assembly 200. In the illustrated form, the latch assembly 200 also includes a return spring 202 biasing the latchbolt 220 toward its extended position.

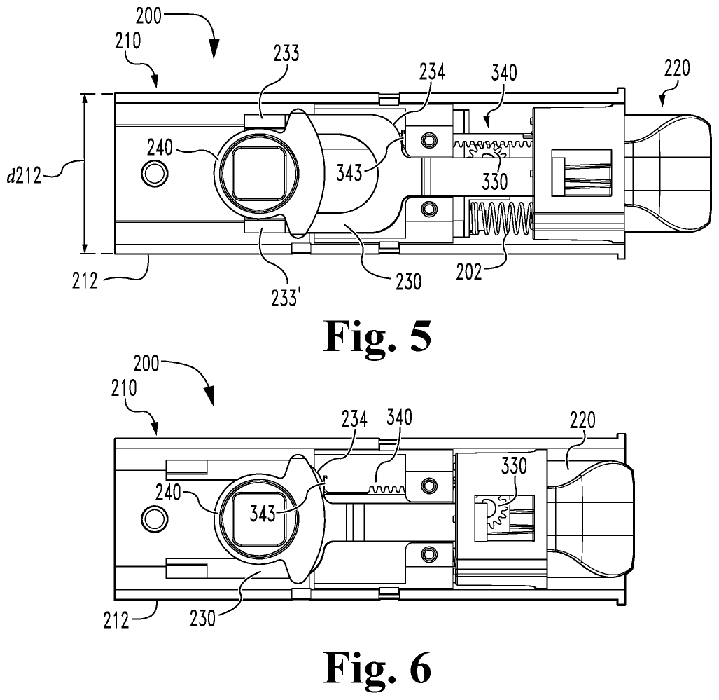

The housing assembly 210 generally includes a tubular latch housing 212 and a faceplate 214 mounted to an outer end 213 of the latch housing 212, and may further include a backplate 216 mounted between the faceplate 214 and the outer end 213 of the latch housing 212. The latch housing 212 is tubular in nature, and is configured for mounting within the latch bore 96. As such, the latch housing 212 may have a diameter d212 (FIG. 5) of one inch or less to ensure that the latch bore 96 is operable to receive the latch housing 212. In the illustrated form, the latch housing 212 includes two housing components 216 that join together to form the latch housing 212, and each of the housing components 218 includes a respective aperture 219.

The latchbolt 220 is mounted in the housing assembly 210 for sliding movement along the lateral axis 102, and generally includes a body 222 and a nose 224. The body 222 is engaged with the bolt bar 230, and the nose 224 is operable to project beyond the faceplate 214 to latch the door 90 in a closed position. In the illustrated form, the bolt is a latchbolt 220 that is biased toward its extended position, for example by a spring 202. In other embodiments, the bolt may instead be provided as an unbiased deadbolt.

The bolt bar 230 is mounted in the housing assembly 210 for sliding movement along the lateral axis 102, and generally includes an arm 232, a shoulder 234 formed at an end of the arm 232, and an extension 236. The arm 232 includes a ridge 233 operable to engage an ear 243 of the drive cam 240 such that the drive cam 240 retracts the bolt bar 230 when the drive cam 240 is rotated in a first direction. In the illustrated form, the bolt bar 230 includes a second arm 232′ that is spaced from the first arm 232 and includes a second ridge 233′. The second ridge 233′ is also operable to engage the ear 243 of the drive cam 240 such that the drive cam 240 retracts the bolt bar 230 when the drive cam 240 is rotated in a second direction opposite the first direction. The extension 236 projects into the latchbolt 220, and includes a flange 237 that engages a shoulder formed within the latchbolt 220 such that retraction of the bolt bar 230 causes a corresponding retraction of the latchbolt 220. As described herein, the extension 236 is engaged with the latchbolt 220 via a one-way pushing engagement such that the latchbolt 220 can be retracted mechanically without moving the bolt bar 230.

The drive cam 240 is rotatably mounted in the housing assembly 210 for rotation about the longitudinal axis 101, and generally includes a first engagement portion 241, a second engagement portion 242 opposite the first engagement portion 241, and an ear 243. The first engagement portion 241 is operable to rotationally couple the drive cam 240 with the outside spindle 116, for example by receiving a mating portion of the outside spindle 116. Similarly, the second engagement portion 242 is operable to rotationally couple the drive cam 240 with the inside spindle 126, for example by receiving a mating portion of the inside spindle 126.

One edge of the ear 243 is operable to engage the ridge 233 for retraction of the bolt bar 230 when the drive cam 240 is rotated in the first direction, and an opposite edge of the ear 243 is operable to engage the second ridge 233′ for retraction of the bolt bar 230 when the drive cam 240 is rotated in the second direction. In the illustrated form, the cam 240 includes a single continuous ear 243, the opposite edges of which are operable to engage the ridges 233, 233′. It is also contemplated that the cam 240 may include a discontinuous ear, such as a pair of fingers, and that such fingers may engage the ridges 233, 233′.

The drive cam 240 may be rotatably supported by at least a portion of the housing assembly 210. For example, the drive cam 240 may include one or more circular bosses 244 that seat in a corresponding aperture 219 such that the drive cam 240 is rotatably supported by the tubular housing 212. In certain forms, a collar 245 may be formed adjacent the circular boss 244 to discourage shifting of the drive cam 240 along its rotational axis 101.

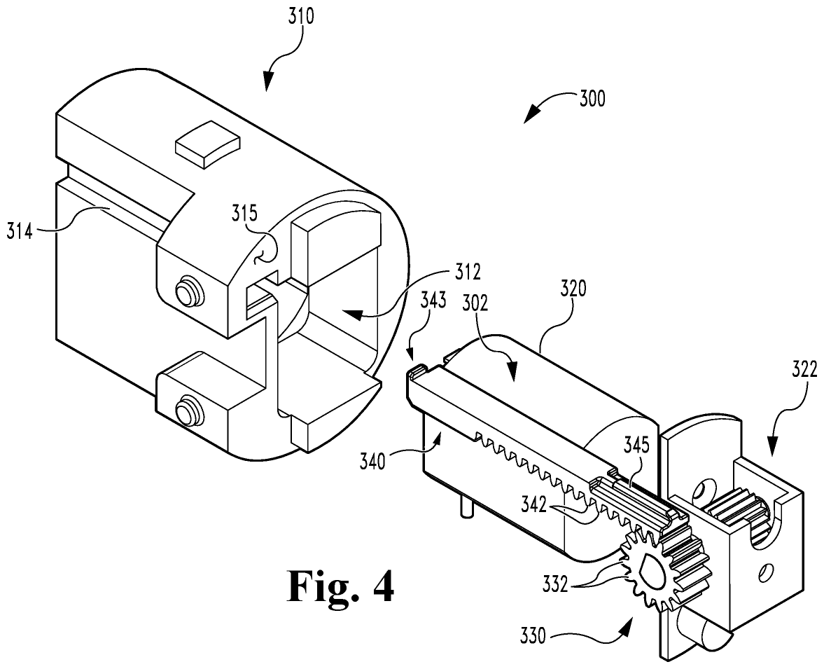

With additional reference to FIG. 4, the illustrated drive assembly 300 generally includes a mounting block 310, a motor 320 mounted to the mounting block 310, a rotary member in the form of a pinion gear 330 operable to be rotated by the motor 320, and a slide member in the form of a rack member 340, which is slidably mounted to the mounting block 310 and engaged with the rotary member 330. As described herein, the rack member 340 is operable to engage and retract the bolt bar 230 to thereby facilitate retraction of the latchbolt 220 by the drive assembly 300.

The mounting block 310 is configured for mounting within the tubular latch housing 212, and generally includes a seat 312 in which the motor 320 is seated, and a channel 314 in which the rack member 340 is slidably received. The seat 312 receives the motor 320 and provides a stable mounting location for the motor 320. The channel 314 slidably receives the rack member 340 for reciprocal motion between a forward position (FIG. 5) and a rearward position (FIG. 6).

The motor 320 is mounted within the seat 312 of the mounting block 310, and includes a motor shaft that is coupled with a gear train 322 that connects the motor 320 with the pinion gear 330. The motor 320 is thus operable to rotate the pinion gear 330 in each of a first direction for retraction of the latchbolt 220 and a second direction for extension of the latchbolt 220. As will be appreciated, the motor 320 may be actuated under control of the controller 132. For example, the controller 132 may transmit to the motor 320 a retracting signal that causes the motor 320 to rotate the pinion gear 330 in the first direction in response to a first criterion (e.g., presentation of an appropriate credential to the credential reader 112), and may transmit to the motor 320 an extending signal that causes the motor 320 to rotate the pinion gear 330 in the second direction in response to a second criterion (e.g., expiration of a relock timer).

As noted above, the pinion gear 330 is operable to be rotated by the motor 320 in each of a first direction and a second direction. The pinion gear 330 includes gear teeth 332, which are engaged with teeth 342 of the rack member 340 such that rotation of the pinion gear 330 causes a corresponding linear movement of the rack member 340. More particularly, rotation of the pinion gear 330 in the first rotational direction is correlated with rearward movement or retraction of the rack member 340, and rotation of the pinion gear 330 in the second rotational direction is correlated with forward movement or extension of the rack member 340.

The rack member 340 is slidably mounted in the channel 314 for reciprocal movement between a forward position and a rearward position. The rack member 340 generally includes rack teeth 342 engaged with gear teeth 332 of the pinion gear 330, and an end portion 343 operable to engage the bolt bar 230. The rack member 340 may further include a limiting ridge 345 operable to abut the front face 315 of the mounting block 310 when the rack member 340 is in its rearward position to thereby prevent further retraction of the rack member 340 beyond its rearward position.

In the illustrated form, the rotary member is provided in the form of a pinion 330, and the slide member is provided in the form of a rack member 340 engaged with the pinion 330. It is also contemplated that other forms of rotary member and/or other forms of slide member may be utilized. For example, while in the illustrated embodiment, teeth of the pinion 330 engage teeth of the rack member 340, it should be appreciated that similar components may lack such teeth. By way of example, a rotary member may instead be frictionally engaged with a slide member.

With additional reference to FIGS. 5 and 6, the latch assembly 200 is operable to retract the latchbolt 220 electronically, for example in response to receiving a retract signal from the control assembly 130. The latch assembly 200 has a home state in which the latchbolt 220 is in its extended position (FIG. 5), and an electronically actuated state in which the latchbolt 220 is in its retracted position (FIG. 6).

With the latch assembly 200 in its home state (FIG. 5), the latchbolt 220 is in its extended position. More particularly, the rack member 340 is in its forward position, which permits the bolt bar 230 and the latchbolt 220 to adopt the extended or forward positions thereof (e.g., under the force of the spring 202). When the motor 320 is activated in a retracting mode (e.g., in response to receiving a retract signal from the controller 132), the motor 320 rotates the pinion 330 in the first rotational direction, thereby driving the rack member 340 in the first linear direction and toward its rearward position. Such rearward movement of the rack member 340 causes the end portion 343 of the rack member 340 to abut the shoulder 234 of the bolt bar 230. This movement retracts the bolt bar 230 and drives the latchbolt 220 toward its retracted position, thereby transitioning the latch assembly 200 to its electronically actuated state (FIG. 6).

With the latch assembly 200 in its electronically actuated state (FIG. 6), the latchbolt 220 is in its retracted position. More particularly, the rack member 340 has been driven to its rearward position, which causes the end portion 343 to engage the shoulder 234 to thereby cause the rack member 340 to hold the bolt bar 230 in its rearward position against the bias force of the spring 202. When the motor 320 is activated in a return or relock mode (e.g., in response to receiving a return or relock signal from the controller 132), the motor 320 rotates the pinion 330 in the second rotational direction, thereby driving the rack member 340 in the second linear direction and toward its forward position. Such forward movement of the rack member 340 causes the end portion 343 of the rack member 340 to move away from the shoulder 234 of the bolt bar 230. This movement permits the bolt bar 230 to be driven toward its extended position by the return spring 202, thereby returning the latch assembly 200 to its home state (FIG. 5).

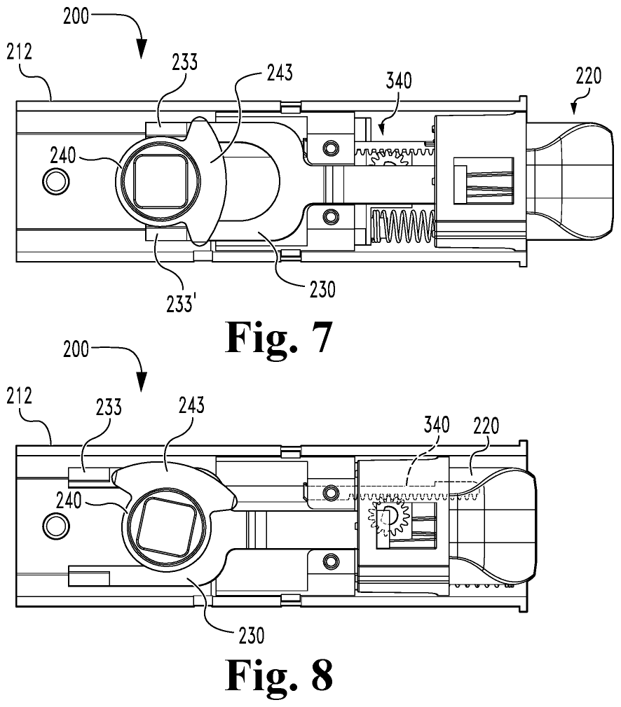

With additional reference to FIGS. 7 and 8, the latch assembly 200 may further be operable to retract the latchbolt 220 mechanically, for example in response to rotation of the drive cam 240 by the spindle 116 and/or the spindle 126. In the illustrated form, the latch assembly 200 has a home state in which the latchbolt 220 is in its extended position (FIG. 7), and a mechanically actuated state in which the latchbolt 220 is in its retracted position (FIG. 8).

With the latch assembly 200 in its home state (FIG. 7), the latchbolt 220 is in the extended position and the rack member 340 is in its forward position. Additionally, the drive cam 240 is in its home position, which permits the bolt bar 230 to adopt its forward or extended position. When the drive cam 240 is rotated in either direction from the home position, a corresponding edge of the ear 243 engages a corresponding one of the ridges 233, 233′ to thereby drive the bolt bar 230 rearward toward its retracted position. As will be appreciated, retraction of the bolt bar 230 to its rearward or retracted position places the latchbolt 220 in its retracted position (FIG. 8), thereby mechanically actuating the latch assembly 200.

With the latch assembly 200 in its mechanically actuated state (FIG. 8), the drive cam 240 is in its rotated position, which places the bolt bar 230 in its rearward position, thereby placing the latchbolt 220 is in its retracted position. However, the rack member 340 remains in its forward position. The rack member 340 is engaged with the bolt bar 230 via a one-way pushing engagement, which causes the rack member 340 to push the bolt bar 230 for retraction of the latchbolt 220 during electronic actuation of the latch assembly 200, while permitting the rack member 340 to remain in its forward position during mechanical actuation of the latch assembly 200.

In the illustrated embodiment, the latch assembly 200 includes a rotary motor 310 and a rack and pinion mechanism 302 that causes linear motion of the bolt bar 230 in response to rotation of the motor shaft of the motor 310. It should be appreciated, however, that other forms of actuator are contemplated as being utilized in the latch assembly 200. For example, the latch assembly 200 may instead include a linear motor operable to drive the bolt bar 230 from its forward position to its rearward position to thereby retract the latchbolt 220.

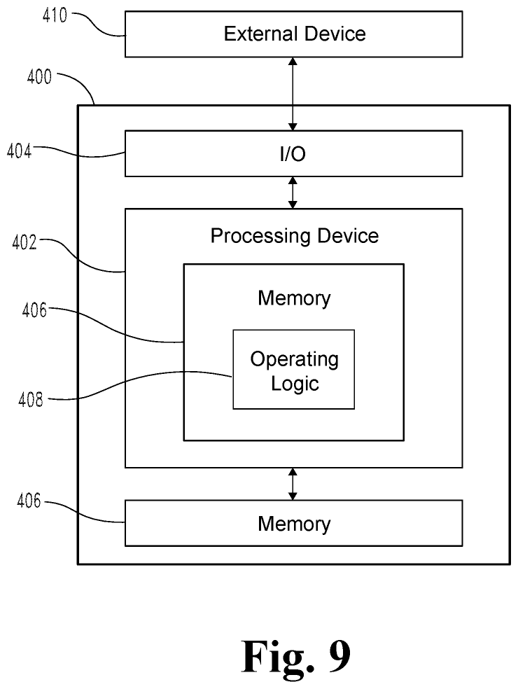

Referring now to FIG. 9, a simplified block diagram of at least one embodiment of a computing device 400 is shown. The illustrative computing device 400 depicts at least one embodiment of a controller that may be utilized in connection with the control assembly 130 illustrated in FIG. 2.

Depending on the particular embodiment, the computing device 400 may be embodied as a server, desktop computer, laptop computer, tablet computer, notebook, netbook, Ultrabook™ mobile computing device, cellular phone, smartphone, wearable computing device, personal digital assistant, Internet of Things (IoT) device, reader device, access control device, control panel, processing system, router, gateway, and/or any other computing, processing, and/or communication device capable of performing the functions described herein.

The computing device 400 includes a processing device 402 that executes algorithms and/or processes data in accordance with operating logic 408, an input/output device 404 that enables communication between the computing device 400 and one or more external devices 410, and memory 406 which stores, for example, data received from the external device 410 via the input/output device 404.

The input/output device 404 allows the computing device 400 to communicate with the external device 410. For example, the input/output device 404 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device 400. The input/output device 404 may include hardware, software, and/or firmware suitable for performing the techniques described herein.

The external device 410 may be any type of device that allows data to be inputted or outputted from the computing device 400. For example, in various embodiments, the external device 410 may be embodied as the credential reader 112, the communication device 136, and/or the motor 320. Further, in some embodiments, the external device 410 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 410 may be integrated into the computing device 400.

The processing device 402 may be embodied as any type of processor(s) capable of performing the functions described herein. In particular, the processing device 402 may be embodied as one or more single or multi-core processors, microcontrollers, or other processor or processing/controlling circuits. For example, in some embodiments, the processing device 402 may include or be embodied as an arithmetic logic unit (ALU), central processing unit (CPU), digital signal processor (DSP), and/or another suitable processor(s). The processing device 402 may be a programmable type, a dedicated hardwired state machine, or a combination thereof. Processing devices 402 with multiple processing units may utilize distributed, pipelined, and/or parallel processing in various embodiments. Further, the processing device 402 may be dedicated to performance of just the operations described herein, or may be utilized in one or more additional applications. In the illustrative embodiment, the processing device 402 is of a programmable variety that executes algorithms and/or processes data in accordance with operating logic 408 as defined by programming instructions (such as software or firmware) stored in memory 406. Additionally or alternatively, the operating logic 408 for processing device 402 may be at least partially defined by hardwired logic or other hardware. Further, the processing device 402 may include one or more components of any type suitable to process the signals received from input/output device 404 or from other components or devices and to provide desired output signals. Such components may include digital circuitry, analog circuitry, or a combination thereof.

The memory 406 may be of one or more types of non-transitory computer-readable media, such as a solid-state memory, electromagnetic memory, optical memory, or a combination thereof. Furthermore, the memory 406 may be volatile and/or nonvolatile and, in some embodiments, some or all of the memory 406 may be of a portable variety, such as a disk, tape, memory stick, cartridge, and/or other suitable portable memory. In operation, the memory 406 may store various data and software used during operation of the computing device 400 such as operating systems, applications, programs, libraries, and drivers. It should be appreciated that the memory 406 may store data that is manipulated by the operating logic 408 of processing device 402, such as, for example, data representative of signals received from and/or sent to the input/output device 404 in addition to or in lieu of storing programming instructions defining operating logic 408. As illustrated, the memory 406 may be included with the processing device 402 and/or coupled to the processing device 402 depending on the particular embodiment. For example, in some embodiments, the processing device 402, the memory 406, and/or other components of the computing device 400 may form a portion of a system-on-a-chip (SoC) and be incorporated on a single integrated circuit chip.

In some embodiments, various components of the computing device 400 (e.g., the processing device 402 and the memory 406) may be communicatively coupled via an input/output subsystem, which may be embodied as circuitry and/or components to facilitate input/output operations with the processing device 402, the memory 406, and other components of the computing device 400. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 400 may include other or additional components, such as those commonly found in a typical computing device (e.g., various input/output devices and/or other components), in other embodiments. It should be further appreciated that one or more of the components of the computing device 400 described herein may be distributed across multiple computing devices. In other words, the techniques described herein may be employed by a computing system that includes one or more computing devices. Additionally, although only a single processing device 402, I/O device 404, and memory 406 are illustratively shown in FIG. 9, it should be appreciated that a particular computing device 400 may include multiple processing devices 402, I/O devices 404, and/or memories 406 in other embodiments. Further, in some embodiments, more than one external device 410 may be in communication with the computing device 400.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A latch assembly, comprising:
a tubular housing;
a latchbolt mounted for sliding movement in the tubular housing between an extended position and a retracted position, wherein the latchbolt is biased toward the extended position;
a slide member slidably mounted within the tubular housing and engaged with the latchbolt such that the slide member is operable to retract the latchbolt;
a rotary member rotatably mounted in the tubular housing and engaged with the slide member; and
a motor operable to rotate the rotary member in a first rotational direction;
wherein rotation of the rotary member in the first rotational direction drives the slide member in a first linear direction to thereby retract the latchbolt.

2. The latch assembly of claim 1, wherein the tubular housing is sized and shaped to be received within a latch bore having a diameter of one inch.

3. The latch assembly of claim 1, further comprising a bolt bar;
wherein the bolt bar is engaged with the slide member such that movement of the slide member in the first linear direction retracts the bolt bar; and
wherein the bolt bar is engaged with the latchbolt such that the latchbolt adopts the retracted position in response to retraction of the bolt bar.

4. The latch assembly of claim 3, further comprising a drive cam rotatably mounted in the housing;
wherein the bolt bar is configured to retract in response to rotation of the drive cam from a home position to a rotated position to thereby retract the latchbolt.

5. The latch assembly of claim 3, wherein the slide member is operable to push the bolt bar in the first linear direction to thereby retract the bolt bar; and
wherein the slide member is inoperable to drive the bolt bar in a second linear direction opposite the first linear direction.

6. The latch assembly of claim 1, wherein the motor is further operable to rotate the rotary member in a second rotational direction opposite the first rotational direction; and
wherein rotation of the rotary member in the second rotational direction drives the slide member in a second linear direction to thereby permit the latchbolt to return to the extended position.

7. A lockset comprising the latch assembly of claim 1, the lockset further comprising a trim configured for mounting to a face of a door;
wherein the trim comprises a controller configured to transmit to the motor a retract signal in response to a first criterion; and
wherein the motor is configured to rotate the rotary member in the first rotational direction in response to the retract signal.

8. The lockset of claim 7, wherein the latch assembly further comprises a drive cam operable to retract the bolt when rotated; and
wherein the trim further comprises a spindle engaged with the drive cam, and a handle operable to rotate the spindle.

9. The lockset of claim 7, further comprising a credential reader; and
wherein the controller is configured to transmit the retract signal based upon information received from the credential reader.

10. The lockset of claim 1, wherein the slide member comprises a rack; and
wherein the rotary member comprises a pinion engaged with the rack.

11. A lockset configured for mounting to a door including a latch bore having a diameter of one inch, the lockset comprising:
a latch assembly configured for mounting in the latch bore, the latch assembly comprising:
a housing configured for mounting within the latch bore;
a latchbolt slidably mounted in the housing; and
a motor mounted in the housing, wherein the motor is engaged with the latchbolt and is configured to retract the latchbolt in response to a retract signal; and
a first trim configured for mounting to a first face of the door, the first trim comprising a controller configured to selectively transmit the retract signal.

12. The lockset of claim 11, wherein the controller is further configured to selectively transmit a return signal; and
wherein the motor is configured to extend the latchbolt in response to the return signal.

13. The lockset of claim 11, further comprising a credential reader in communication with the controller;
wherein the controller is configured to selectively transmit the retract signal based upon information received from the credential reader.

14. The lockset of claim 13, further comprising a second trim configured for mounting to a second face of the door, wherein the second trim comprises the credential reader.

15. The lockset of claim 11, wherein the motor comprises a rotary motor.

16. The lockset of claim 15, wherein the latch assembly further comprises:
a rack member mounted within the housing and configured to retract the bolt when the rack member is moved in a first linear direction; and
a pinion engaged with the rack member such that the rack member moves in the first linear direction in response to rotation of the pinion in a first rotational direction; and
wherein the rotary motor is operable to rotate the pinion in the first rotational direction.

17. A method of operating an electronic latch assembly mounted within a latch bore having a diameter of one inch, the method comprising:
receiving, by the latch assembly, a retract signal; and
in response to receiving the retract signal, activating a motor within the latch bore to thereby operate the motor in a retracting mode;
wherein operating the motor in the retracting mode drives a bolt of the latch assembly from an extended position, in which the bolt projects from the latch bore, to a retracted position, in which the bolt is retracted into the latch bore.

18. The method of claim 17, wherein the latch bore is formed within a door; and
wherein the method further comprises transmitting, by a trim mounted to a face of the door, the retract signal based upon credential information received from a credential reader.

19. The method of claim 18, further comprising transmitting, by the trim, a return signal a predetermined period of time following transmission of the retract signal; and
in response to receiving the return signal, activating the motor within the latch bore to thereby operate the motor in a returning mode;
wherein operating the motor in the returning mode results in movement of the bolt from the retracted position to the extended position.

20. The method of claim 17, wherein operating the motor in the retracting mode comprises:
rotating, by the motor, a pinion gear in a first rotational direction; and
driving, by the pinion gear, a rack member in a first linear direction; and
wherein the bolt retracts in response to movement of the rack member in the first linear direction.

21. The method of claim 17, wherein the bolt is a latchbolt that is spring-biased toward the extended position.
